(19) United States
(12) Patent Application Publication
(10) Pub. No.: US 2005/0056578 A1
(43) Pub. Date: Mar. 17, 2005

(54) Portable apparatus for the magnetic treatment of fluids

(76) Inventors: Jeffrey Keith Switzer, San Diego, CA (US); Paul David Wormuth, Alexandria, VA (US)

Correspondence Address: PAUL WORMUTH, 125 S. FAIRFAX ST., ALEXANDRIA, VA, 22314, US

(21) Appl. No.: 10/660,137

(22) Filed: Sep. 11, 2003

(51) Int. Cl. C02F 1/48

(52) U.S. Cl. 210/222; 210/241

(57) ABSTRACT

A portable apparatus is disclosed for magnetically treating fluids. The device creates a turbulent fluid flow pattern within itself while subjecting the flow to a magnetic field. The device contains one or more magnets. The orientation of multiple magnets within the device are arranged in a non-parallel position with respect to one another. The magnetic field is directed through the flow in a non-parallel and non-perpendicular orientation.

### CROSS REFERENCE TO RELATED APPLICATIONS

Cross-Reference to Related Applications

| | | | |
|---|---|---|---|
| 4,999,106 | March, 1991 | Schindler | 210/222; 210/223 |
| 6,056,872 | May, 2000 | Glass | 210/223; 123/538; 166/66.5 |
| 6,143,171 | April, 1999 | Van Aarsen | 210/222; 96/1; 123/538; 210/695 |

Other References
“Introduction to Fluid Mechanics”; Fox, Robert W. and McDonald, Alan T.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The invention pertains to the magnetic treatment of fluids or gases.

Fluid magnetic treatment devices of prior art such as U.S. Pat. No. 4,999,106 (Schindler) had magnets oriented parallel to each other. Schindler also specified the magnets are parallel to the flow direction. Prior art devices, as in the case with Schindler, were generally designed to minimize flow disruption.

Prior art such as U.S. Pat. No. 6,056,872 (Glass) has had the magnets arranged on the periphery of a tubular section that together would comprise the device. This type of device took on a large shape and consequently became a heavy structure.

In U.S. Pat. No. 6,143,171 (Van Aarsen) fluids flow longitudinally around the treatment device, and not within the arrangement of magnets.

### BRIEF SUMMARY OF THE INVENTION

It is the primary object of the invention to be portable light structure so that it can be handled and installed easily into any fluid system.

The secondary objective of the invention is to create a non-linear fluid flow with a non-constant flow profile condition within the device when fluid passes through it.

It is a further objective of the invention to have the magnets be positioned so that they are non-parallel and non-perpendicular to the fluid flow and non-parallel and non-perpendicular with respect to one another.

It is another object of the invention to improve magnetic treatment of flowing fluids by means of the stated objectives above.

The invention consists of having magnets arranged within a portable device that can be installed into a system in order to magnetically treat the fluid within that system. The device can be removed, cleaned, and reinstalled with ease due to nature of it being a lightweight structure.

Other objects and advantages of the present invention will become apparent from the following descriptions, taken in connection with the accompanying drawings, wherein, by way of illustration and example, an embodiment of the present invention is disclosed.

In summary, the embodiment of the device is to simultaneously create a non-linear flow condition of the fluid while subjecting it to magnetic fields with non-parallel and non-perpendicular boundary forces. The magnets also maintain a non-parallel and non-perpendicular orientation with respect to one another. Furthermore, in the present invention, magnets of different materials, size and shape may be used.

### BRIEF DESCRIPTION OF TH DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1—Configuration One, front view. The arrows at the top and bottom of the view indicate the inlet and outlet directions. The housing of the apparatus is in a wireframe view, so that it can be seen but also seen through to allow the arrangement of the magnets and deflectors to be displayed. The magnets are shown in solid dark.

FIG. 2—Configuration One, top view, view of inlet. The housing of the apparatus is in a wireframe view, so that it can be seen but also seen through to allow the arrangement of the magnets and deflectors to be displayed. The magnets are shown lightly shaded to aid visual identity.

FIG. 3—Configuration One, bottom view, view of outlet. The housing of the apparatus is in a wireframe view, so that it can be seen but also seen through to allow the arrangement of the magnets and deflectors to be displayed. The magnets are shown lightly shaded to aid visual identity.

FIG. 4—Configuration One, 3D view. The housing of the apparatus is in a wireframe view, so that it can be seen but also seen through to allow the arrangement of the magnets and deflectors to be displayed. The magnets are shown in solid dark.

FIG. 5—Configuration Two, front view. The arrows at the top and bottom of the view indicate the inlet and outlet directions. The housing of the apparatus is in a wireframe view, so that it can be seen but also seen through to allow the arrangement of the magnets and deflectors to be displayed. The magnets are shown in solid dark.

FIG. 6—Configuration Two, side view. The housing of the apparatus is in a wireframe view, so that it can be seen but also seen through to allow the arrangement of the magnets and deflectors to be displayed. The magnets are shown in solid dark.

FIG. 7—Configuration Two, top view, view of inlet. The housing of the apparatus is in a wireframe view, so that it can be seen but also seen through to allow the arrangement of the magnets and deflectors to be displayed. The magnets are shown lightly shaded to aid visual identity.

FIG. 8—Configuration Two, bottom view, view of outlet. The housing of the apparatus is in a wireframe view, so that it can be seen but also seen through to allow the arrangement of the magnets and deflectors to be displayed. The magnets are shown lightly shaded to aid visual identity.

FIG. 9—Configuration Two, 3D view. The housing of the apparatus is in a wireframe view, so that it can be seen but also seen through to allow the arrangement of the magnets and deflectors to be displayed. The magnets are shown in solid dark.

FIG. 10—Configuration Three, front view. The arrows at the top and bottom of the view indicate the inlet and outlet directions. The housing of the apparatus is in a wireframe view, so that it can be seen but also seen through to allow the arrangement of the magnets and deflectors to be displayed. The magnets are shown in solid dark.

FIG. 11—Configuration Three, top view, view of inlet. The housing of the apparatus is in a wireframe view, so that it can be seen but also seen through to allow the arrangement of the magnets and deflectors to be displayed. The magnets are shown lightly shaded to aid visual identity.

FIG. 12—Configuration Three, bottom view, view of outlet. The housing of the apparatus is in a wireframe view, so that it can be seen but also seen through to allow the arrangement of the magnets and deflectors to be displayed. The magnets are shown lightly shaded to aid visual identity.

FIG. 13—Configuration Three, 3D view. The housing of the apparatus is in a wireframe view, so that it can be seen but also seen through to allow the arrangement of the magnets and deflectors to be displayed. The magnets are shown in solid dark.

### D TAILED DI CLOSUR OF TH PR F RR D EMBODIMENT

The housing of the apparatus 1, 3, and 5 is pictured in wireframe view to enhance the visual clarity of the magnet's orientations. The housing is intended to be made of any non-magnetic material that is suitable to the environment it is to be used in. The deflectors and magnets can be fixated to the housing by means of any epoxy bond, screw, snap-fit, or any such method of securing them to the housing.

All the configurations shown in the drawings share the common characteristics outlined in the claims which encompass the following: A) The flow gets channeled to a non-uniform velocity profile by means of deflectors. B) These deflectors create a non-linear fluid flow condition within the apparatus. C) These deflectors can be of magnetic substance or of a different material as long as the fluid possesses a non-uniform velocity profile within the apparatus and is subjected to a magnetic boundary force. D) The magnetic boundary force or field is non-parallel and non-perpendicular to the direction of flow while the orientation of the magnets is such that they are non-parallel and non-perpendicular with respect to one another.

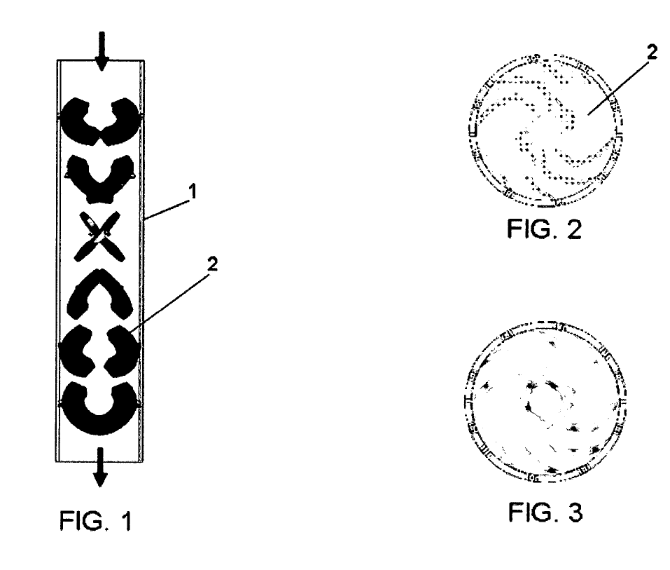

In configuration one, FIGS. 1, 2, 3, and 4, the magnet deflectors 2 are placed in a spiraling path along the inner surface of the housing 1. There are multiple spiraling path sets of magnet deflectors. The magnets are positioned in such a way that they are non-parallel and non-perpendicular to the fluid flow and non-parallel and non-perpendicular with respect to one another. This arrangement of magnet deflectors directs the flow to swirl, creating a non-uniform velocity profile within the apparatus.

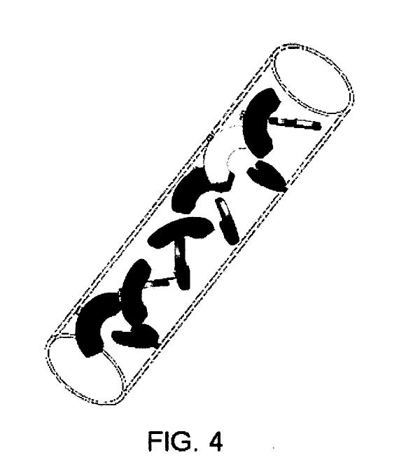

FIG. 4 is a three-dimensional view of configuration one that aids the visual clarity of the apparatus design for this configuration by showing the paths of magnets spiraling along the inner surface of the housing.

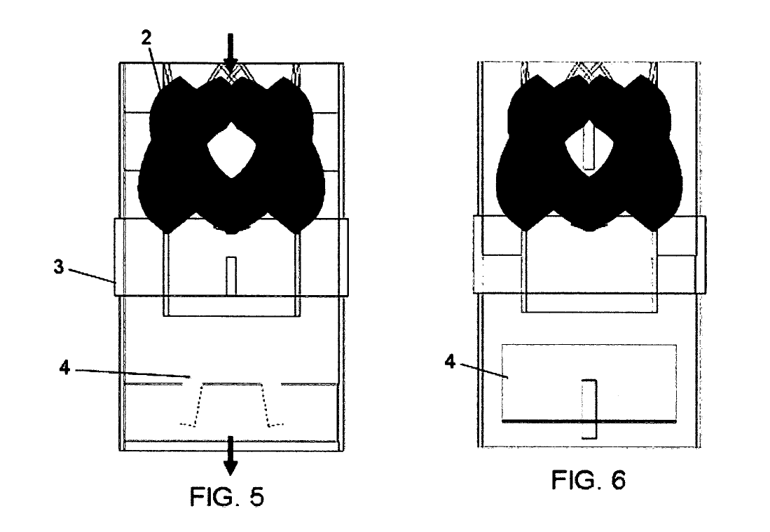

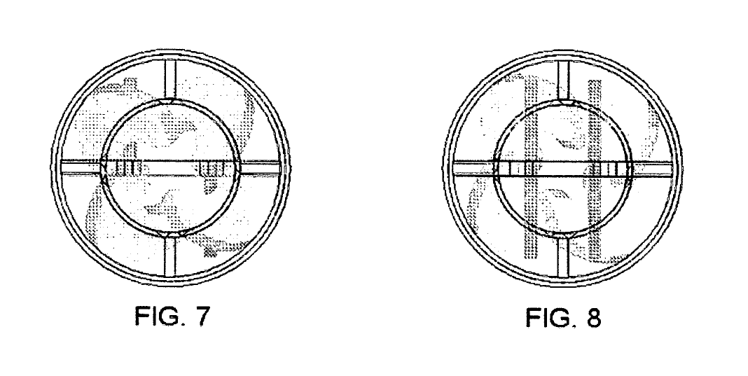

Similar to configuration one, configuration two, FIGS. 5, 6, 7, 8, and 9, has magnet deflectors 2 at the inlet of the housing 3 that swirl the flow upon entering the device, creating a non-uniform velocity profile flow condition. The top set of magnets are positioned on an inner circular frame such that they non-parallel and non-perpendicular to the flow, and the magnets are non-parallel and non-perpendicular with respect to each other.

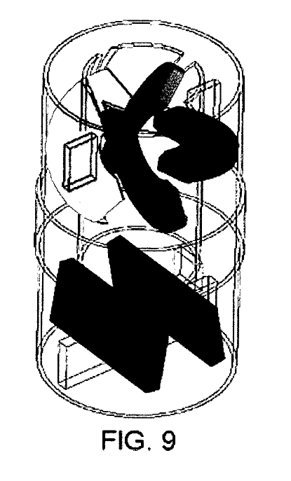

FIGS. 5 and 6 show that different magnet 4 configurations can be used (i.e. flat magnets, curved magnets, etc.). Regardless of the shape of the magnet, their placement remains non-parallel and non-perpendicular to the flow, and the magnets are non-parallel and non-perpendicular with respect to each other. FIG. 9 is a three-dimensional view of configuration two that aids the visual clarity of the apparatus design for this configuration by showing that the magnets are positioned to maintain non-linear fluid flow condition.

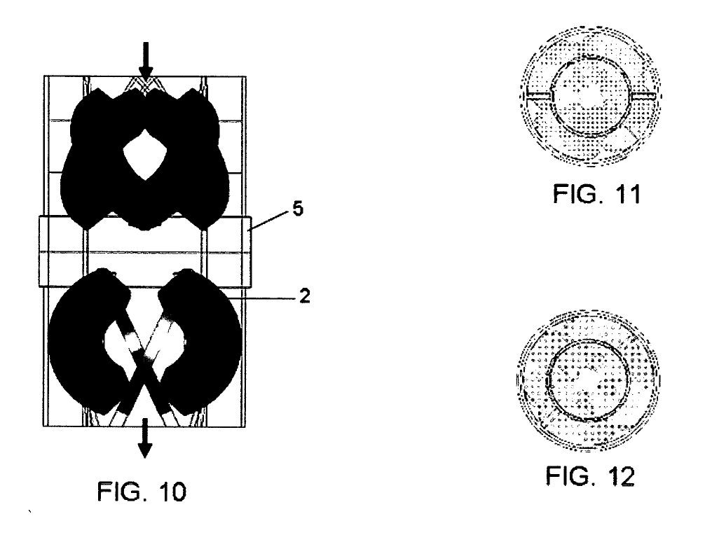

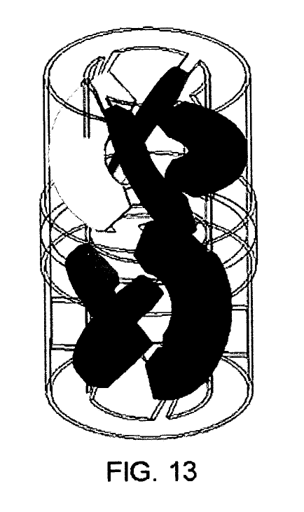

Configuration three, FIGS. 10, 11, 12, and 13, is similar to configuration two such that the orientation of the top set of magnets is set up around an inner frame 5, designed to swirl the flow to a non-uniform velocity profile condition. The bottom set of magnets 2 are also set up on an inner circular frame that will swirl the flow in the opposite direction relative to the top set of magnets, continuing to condition the flow to a non-uniform velocity profile. The magnets are positioned in such a way that they are non-parallel and non-perpendicular to the fluid flow and non-parallel and non-perpendicular with respect to one another. FIG. 13 is a three-dimensional view of configuration three that aids the visual clarity of the apparatus design for this configuration by showing that the bottom set of magnets are directed in opposition to the top set of magnets, sustaining the flow be deflected by the magnets to spiral within the apparatus.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A portable device to be placed in a fluid flow, that is an apparatus for magnetically treating fluids:

2. A non-uniform velocity profile is established within the said portable device in claim 1.

3. Non-linear fluid flow within the said device of claim 1 is established by means of directing the fluid with magnetic or non-magnetic deflectors through passageways

4. The fluid flow velocity profile within the said portable device in claim 1 is non-parallel and non-perpendicular to the magnet or magnets

5. The orientation of the magnets within the said portable device in claim 1 are arranged in a non-parallel and non-perpendicular position with respective to one another.

6. The said portable device of claim 1 may take on different design configurations that satisfy the claims 2, 3, 4, and 5.

7. The said portable device in claim 1 may contain different shaped magnets.
